(19) United States
(12) Patent Application Publication
(10) Pub. No.: US 2005/0022170 A1
(43) Pub. Date: Jan. 27, 2005

(54) Visual debugging interface

(76) Inventors: Hans-Frederick Brown, Montreal (CA); Sylvio Drouin, Montreal (CA); Bruno Braen, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/857,434

(22) Filed: Jun. 1, 2004

Related U.S. Application Data
(60) Provisional application No. 60/474,234, filed on May 30, 2003.

(51) Int. Cl. G06F 9/44

(52) U.S. Cl. 717/125

(57) ABSTRACT

The present invention relates to a method of providing a debugging interface, comprising: executing the program comprising a plurality of program objects; searching the plurality of program objects for at least one criterion of incoherence wherein ones of the plurality of program objects that meet at least one of the at least one criterion are identified as target program objects; searching the plurality of program objects for program objects upon which at least one target program object is dependent, wherein ones of the plurality of program objects upon which at least one target program object is dependent are identified as suspect program objects; and indicating at least one target program object and at least one suspect program object from the plurality of program objects.

The present application claims priority of U.S. provisional patent application 60/474,234 filed May 30, 2003.

### BACKGROUND OF THE INVENTION

(a) Field of the Invention

The invention relates generally to providing a visual interface for testing and debugging programs, and more particularly, to providing in the context of visual object-oriented programming a visual interface for defining and detecting errors, distinguishing icons representing program objects in which the errors were detected, those which might have been responsible for the detected errors, as well as those through which the detected errors might have been propagated.

(b) Description of Prior Art

The development of software applications has traditionally been a time-consuming task. In order to overcome the limitations of traditional techniques, new software development tools have been created. Some of those tools aim at improving an efficiency with which software testing and debugging is performed. The term “testing” is generally known in the industry to designate the process by which errors are detected, and “debugging”, the process by which a cause for a detected error is identified. Traditional debugging methods are laborious, and generally involve following the flow of a program line-by-line and inserting print statements at particular locations so that variables and the like may be checked to determine whether their values correspond to expectations.

In order to facilitate the debugging process, computer programs called “debuggers” have been created.

A debugger is generally a tool that aids software development by giving a programmer control over, and access to, information concerning a running application program. It typically runs as a self-contained process, controlling the program under study through operating system primitives specifically designed for that purpose. One of the features usually provided by debuggers is known as “single-stepping” and involves executing only one program instruction at a time. Another equally useful feature consists in displaying a content of computer registers and memory locations. A third common feature consists in setting breakpoints at particular locations in the program, wherein a breakpoint provokes an interruption of an execution of the program.

Other software development tools target the efficiency with which program objects are created and combined. The most notable ones allow users to design applications visually, by drag-and-dropping objects in a workspace and establishing links between those objects. However, such tools force users to debug resulting programs using non-visual, debugging mechanisms, such as inserting break points and single stepping.

U.S. Pat. No. 6,131,185, titled “Method and system for visually debugging an object in an object-oriented system”, describes a method and a system for storing data during an execution of a program in order to provide multiple entry points for an ensuing debugging process. Although the method and system are useful for debugging programs from various entry points in accordance with detected errors, it does not provide means for identifying icons representing program objects in which the errors were detected, those which might have been responsible for the detected errors, as well as those through which the detected errors might have been propagated, in a context of visual object-oriented programming.

### SUMMARY OF THE INVENTION

It would be desirable to be provided with a graphical debugging interface for defining and detecting errors, distinguishing icons representing program objects in which the detected errors were located, those that might have been responsible for the detected errors, as well as those through which the detected errors might have been propagated, in a context of visual object-oriented programming.

In accordance with the present invention, there is provided a method of providing a debugging interface, comprising: executing the program comprising a plurality of program objects; searching the plurality of program objects for at least one criterion of incoherence wherein ones of the plurality of program objects that meet at least one of the at least one criterion are identified as target program objects; searching the plurality of program objects for program objects upon which at least one target program object is dependent, wherein ones of the plurality of program objects upon which at least one target program object is dependent are identified as suspect program objects; and indicating at least one target program object and at least one suspect program object from the plurality of program objects.

In accordance with one embodiment of the present invention, the indicating comprises providing a display of a plurality of nodes wherein each node represents one of the plurality of program objects, providing for each node of the display a first visual indication of whether a corresponding program object is one of the at least one target program object, and providing for each node of the display a second visual indication of whether a corresponding program object is one of the at least one suspect program object.

In accordance with one embodiment of the present invention, the method further comprises specifying the at least one criterion of incoherence.

In accordance with one embodiment of the present invention, the method further comprises displaying a list of criteria, wherein the specifying comprises a user selecting the at least one criterion of incoherence from the list.

In accordance with one embodiment of the present invention, the method further comprises specifying the first visual indication.

In accordance with one embodiment of the present invention, the method further comprises specifying the second visual indication.

In accordance with one embodiment of the present invention, the method further comprises displaying a list of visual indications, wherein the specifying the first visual indication comprises selecting the first visual indication from the list of visual indications, and the specifying the second visual indication comprises selecting the second visual indication from the list of visual indications.

In accordance with one embodiment of the present invention, the first visual indication is a square surrounding a node for which it is provided, and the second visual indication is a circle surrounding a node for which it is provided.

In accordance with one embodiment of the present invention, at least one of the at least one criterion is a combination of a filtered variable and a group of at least two predicates, the at least one target program object comprises the filtered variable, and a value of the filtered variable fulfills at least one predicate of the group.

In accordance with one embodiment of the present invention, the method further comprises selecting at least one of said plurality of program objects as comprised in a search group, wherein a scope of said searching said plurality of program objects for at least one criterion of incoherence is restricted to ones of said plurality of program objects comprised in said search group.

In accordance with one embodiment of the present invention, the method further comprises requesting for the first visual indication to be provided, wherein the providing for each node a first visual indication is performed in response to the requesting.

In accordance with one embodiment of the present invention, the method further comprises requesting for the second visual indication to be provided, wherein the providing for each node a second visual indication is performed in response to the requesting.

In accordance with one embodiment of the present invention, the method further comprises storing a list of the at least one target program object, requesting for the list to be retrieved, and displaying the list in response to the requesting.

In accordance with one embodiment of the present invention, the method further comprises displaying a plurality of links, each link relating directly at least two of the plurality of nodes, providing a third visual indication for a link that relates a program object to the at least one target program object either directly or through other program objects.

In accordance with one embodiment of the present invention, the method further comprises searching the plurality of program objects for program objects upon which at least one target program object is dependent, wherein ones of the plurality of program objects dependent upon at least one target program object are identified as victim program objects, and indicating at least one victim program object from the plurality of program objects.

In accordance with the present invention, there is provided a computer program product for providing a debugging interface comprising a computer usable storage medium having computer readable program code means embodied in the medium, the computer readable program code means comprising: computer readable program code means for executing the program comprising a plurality of program objects; computer readable program code means for searching the plurality of program objects for at least one criterion of incoherence wherein ones of the plurality of program objects that meet at least one of the at least one criterion are identified as target program objects; computer readable program code means for searching the plurality of program objects for program objects upon which at least one target program object is dependent, wherein ones of the plurality of program objects upon which at least one target program object is dependent are identified as suspect program objects; computer readable program code means for indicating at least one target program object and at least one suspect program object from the plurality of program objects.

In accordance with one embodiment of the present invention, the computer program means for indicating comprises computer program means for providing a display of a plurality of nodes wherein each node represents one of the plurality of program objects, computer program means for providing for each node of the display a first visual indication of whether a corresponding program object is one of the at least one target program object, and computer program means for providing for each node of the display a second visual indication of whether a corresponding program object is one of the at least one suspect program object.

In accordance with one preferred embodiment of the present invention, the computer program product further comprises computer readable program code means for specifying the at least one criterion of incoherence.

In accordance with one preferred embodiment of the present invention, the computer program product further comprises computer readable program code means for displaying a list of criteria, wherein the computer readable program code means for specifying comprises computer readable program code means for a user to select the at least one criterion of incoherence from the list.

In accordance with one preferred embodiment of the present invention, the computer program product further comprises computer readable program code means for specifying the first visual indication.

In accordance with one preferred embodiment of the present invention, the computer program product further comprises computer readable program code means for specifying the second visual indication.

In accordance with one preferred embodiment of the present invention, the computer program product further comprises computer readable program code means for displaying a list of visual indications, wherein the computer readable program code means for specifying the first visual indication comprises computer readable program code means for selecting the first visual indication from the list of visual indications, and the computer readable program code means for specifying the second visual indication comprises computer readable program code means for selecting the second visual indication from the list of visual indications.

In accordance with one preferred embodiment of the present invention, the first visual indication is a square surrounding a node for which it is provided, and the second visual indication is a circle surrounding a node for which it is provided.

In accordance with one preferred embodiment of the present invention, at least one of the at least one criterion is a combination of a filtered variable and a group of at least two predicates, the at least one target program object comprises the filtered variable, and a value of the filtered variable fulfills at least one predicate of the group.

In accordance with one preferred embodiment of the present invention, the computer program product further comprises computer readable program code means for selecting at least one of the plurality of program objects as comprised in a search group, wherein a scope of the searching the plurality of program objects for at least one criterion of incoherence is restricted to ones of the plurality of program objects comprised in the search group.

In accordance with one preferred embodiment of the present invention, the computer program product further comprises computer readable program code means for requesting for the first visual indication to be provided, wherein the computer readable program code means for providing for each node a first visual indication is performed in response to the requesting.

In accordance with one preferred embodiment of the present invention, the computer program product further comprises computer readable program code means for requesting for the second visual indication to be provided, wherein the computer readable program code means for providing for each node a second visual indication is performed in response to the requesting.

In accordance with one preferred embodiment of the present invention, the computer program product further comprises computer readable program code means for storing a list of the at least one target program object, computer readable program code means for requesting for the list to be retrieved, and computer readable program code means for displaying the list in response to the requesting.

In accordance with one preferred embodiment of the present invention, the computer program product further comprises computer readable program code means for displaying a plurality of links, each link relating directly at least two of the plurality of nodes, and computer readable program code means for providing a third visual indication for a link that relates a program object to the at least one target program object either directly or through other program objects.

In accordance with one preferred embodiment of the present invention, the computer program product further comprises computer readable program code means for searching the plurality of program objects for at least one victim program object dependent upon the at least one target, and computer readable program code means for providing for each node a third visual indication of whether a corresponding program object is the at least one victim.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a block diagram of an exemplary implementation of the present invention;

FIG. 2 illustrates an application window comprising a first pane presenting a view of a hierarchical structure of a program, and a second pane presenting a view of a data flow structure of the program;

FIG. 3 illustrates the window comprising the first and second panes, wherein a Filter menu is displayed;

FIG. 4 illustrates the window comprising the first and second panes, as well as a third pane providing means for establishing a set of filters;

FIG. 5 illustrates the window comprising the first, second, and third panes, wherein a set of filters is being established;

FIG. 6 illustrates the window comprising the first, second, and third panes, as well as a fourth pane providing means for assigning a name to, and saving, an established set;

FIG. 7 illustrates the window comprising the first and second panes, as well as a third pane providing means for selecting a saved set in order for its settings to be displayed;

FIG. 8 illustrates the window comprising the first and second panes, as well as the third pane providing means for establishing a set of filters, wherein a filter is added to the selected saved set;

FIG. 9 illustrates the window comprising the first and second panes, as well as a third pane providing means for selecting visual indicators;

FIG. 10 illustrates the window comprising the first and second panes, as well as a third pane providing means for applying saved sets of filters;

FIG. 11 illustrates the window comprising the first and second panes, as well as the third pane providing means for applying saved sets of filters, and a fourth pane presenting a view of results of a last execution of the program, wherein a set is selected through the third pane, and visual indicators are provided to nodes displayed in the second pane according to the selected set and the last execution of the program;

FIG. 12 illustrates the window comprising the first and second panes, as well as the third pane providing means for applying saved sets of filters, and the fourth pane, wherein a complementary set is selected through the third pane, and visual indicators are provided to nodes displayed in the second pane according to the selected set and a last execution of the program; and

FIG. 13 illustrates the window comprising the first and second panes, as well as the third pane providing means for applying saved sets of filters, and the fourth pane, wherein visual indicators are provided to nodes displayed in the second pane according to a selected set of filters, and a tool tip describing a detected error is displayed as associated to a node representing a corresponding program object.

### DETAILED DESCRIPTION OF THE INVENTION

In object-oriented programming, two debugging approaches have been traditionally taken.

The first approach favours creative flows, and consists in writing the entire program without performing any tests, wherein programmers may fully concentrate on creating objects and data flows. It is only after the program is entirely created that it is tested and debugged. Such an approach involves a time-consuming debugging process, as inadvertent errors may be scattered across the program. In order to determine the cause of a detected error, relevant objects are isolated, and tested, individually and in combination with others.

The second approach is more conservative, and consists in testing program objects as they are created. The time spent on debugging is greatly reduced as a scope of a search performed to locate a cause of a detected error is constrained to objects being tested. However, such an approach disturbs a flow with which objects are created, as each creation of an object is followed by a corresponding testing and debugging process.

Although an efficiency of the two approaches has been improved with the advent of sophisticated debuggers, their weaknesses are sustained by the growing complexity of computer programs. The present invention provides a method for guiding users in their search for causes of detected errors in the context of visual programming. The method is particularly useful in cases where programs are debugged according to the first approach.

The present invention is described in the context of a program called “Calculator”, implementing a scaling engine designed to calculate a new dimension of an image according to its current dimension, as well as a given scaling factor and operation. The current dimension is multiplied or divided by the given factor, depending on whether the image is to be enlarged or reduced.

In the preferred embodiment, the program is saved as a tree, each node of the tree representing a data object which typically contains data, a list of data flow relationships comprised of pointers to other objects with which data is exchanged, as well as pointers to their parent, and children.

In another embodiment, the program is saved as three lists and a table, wherein the first list is comprised of all data objects of the program, the second, of all data flow relationships amongst the data objects, and a third, of all hierarchical relationships amongst the data objects.

It will be appreciated that the graphical elements discussed below are exemplary and any distinctive graphical elements, whether static or dynamic, may be substituted for the graphical elements discussed below without departing from the spirit of the invention.

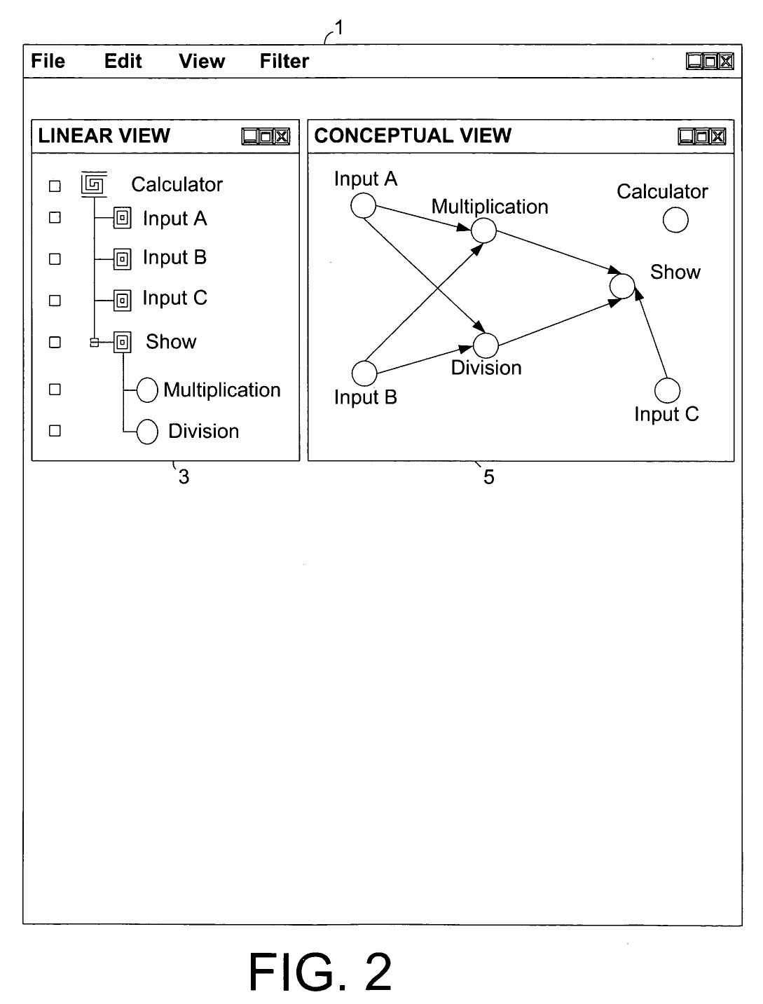

FIG. 2 illustrates an application window 1, comprising a first pane 3 presenting a view of a hierarchical structure of the program, and a second pane 5 presenting a view of its data flow structure.

In the pane 3, there are shown seven labeled nodes organized in a hierarchical structure, wherein each node represents an object of the program. In the following description, node labels shall be taken to designate corresponding nodes as well as their underlying objects.

Two program objects are said to have a hierarchical relation when one of the two calls the other. The calling object is known as “the parent” of the called object, and the latter, “a child” of the calling object. Furthermore, each object of a program has one parent and one parent only, except for an object embodying a reference to the program. It is also important to note that a parent may have more than one child.

In the preferred embodiment, a node representing a child is displayed under, linked to, and indented relatively to, another node representing its parent.

However, in another embodiment, nodes are scattered across the pane 3, and arrows indicate hierarchical relationships amongst corresponding program objects. In yet another embodiment, the window 1 does not comprise a pane presenting a view of the hierarchical structure of the program.

A node labeled “Calculator” represents a program object that serves no algorithmic purpose, other than providing a starting point for executing the program. It comprises four children represented by nodes labeled “Input A”, “Input B”, “Input C”, and “Show”.

The object Input A is responsible for retrieving a current dimension of an image from a rendering engine, and assigning it to a variable labeled “Dim”. On the other hand, the object Input B is responsible for retrieving a scaling factor specified by the user through an I/O device, and assigning it to a variable labeled “Factor”. As for the object Input C, it is responsible for retrieving a scaling operation specified by a user through an I/O device, and assigning it to a variable labeled “Op”. Neither one of the three latter objects is considered a parent since they do not have any children.

The object Show is responsible for retrieving a value assigned to the variable Op. If the retrieved value indicates a request for enlarging a current image, the object Show retrieves from an object represented by a node labeled “Multiplication” a product of values assigned to the variables Dim and Factor. If on the other hand, the retrieved value indicates a request for reducing the image, the object Show retrieves their quotient from an object represented by a node labeled “Division”. The retrieved mathematical result represents a scaled dimension of the current image corresponding to requirements of the user, and is assigned to a variable labeled “NewDim”, which may be accessed by a rendering engine in order to adjust a display of the current image accordingly. The object Show has two children, namely the objects Multiplication and Division.

The object Multiplication is responsible for retrieving from the object Input A the value assigned to the variable Dim, from the object Input B, that assigned to the variable Factor, multiplying the two retrieved values, and assigning the result to a variable labeled “Product”. The object Multiplication is not considered a parent since it does not have any children.

The object Division is responsible for retrieving from the object Input A the value assigned to the variable Dim, from the object Input B, that assigned to the variable Factor, dividing the former retrieved value by the latter, and assigning the result to a variable labeled “Quotient”. The object Division is not considered a parent since it does not have any children.

In the pane 5, there are shown the seven aforementioned nodes and seven arrows, each of which represents a data flow between two corresponding objects.

As mentioned previously, the object Multiplication retrieves the current dimension of the image and the required scaling factor in order to multiply the latter values and assign the result to the variable Product. The corresponding data flows are represented by two arrows originating from the objects Input A and Input B, and destined for the object Multiplication.

The object Division retrieves the same values as the object Multiplication in order to divide them and assign the result to the variable Quotient. The corresponding data flows are represented by two arrows originating from the objects Input A and Input B, and destined for the object Division.

Once the mathematical operations are performed, the object Show retrieves a scaling operation from the object Input C. The corresponding flow of a value assigned to the variable Op is represented by an arrow originating from the object Input C, and destined for the object Show. Thereafter, the object Show retrieves a scaled dimension from either one of the objects Multiplication and Division, according to the required scaling operation. The corresponding data flows are represented by arrows originating from the objects Multiplication and Division, and destined for the object Show.

As previously mentioned, the present invention highlights objects in which errors are detected, those that might have been responsible for the detected errors, as well as those through which the detected errors might have been propagated. In the following description, the term “target object” shall be taken to designate a program object in which at least one error is detected, the term “suspect object”, an object in which a cause of a detected error might be comprised aside from the corresponding target object, and the term “victim object”, an object through which a detected error might have been propagated aside from the corresponding target object.

In order for erroneous variable values to be detected, they must previously be defined by a user according to his understanding of the program. In the preferred embodiment, the user selects an entry “New Set” from the Filter Menu, in response to which a third pane is displayed within the window 1, wherein the third pane provides means for establishing a set of filters according to potential errors. In the case where no erroneous values are defined, the ensuing debugging process will only target conventional errors detectable through prior art debuggers, such as null pointers and overflows.

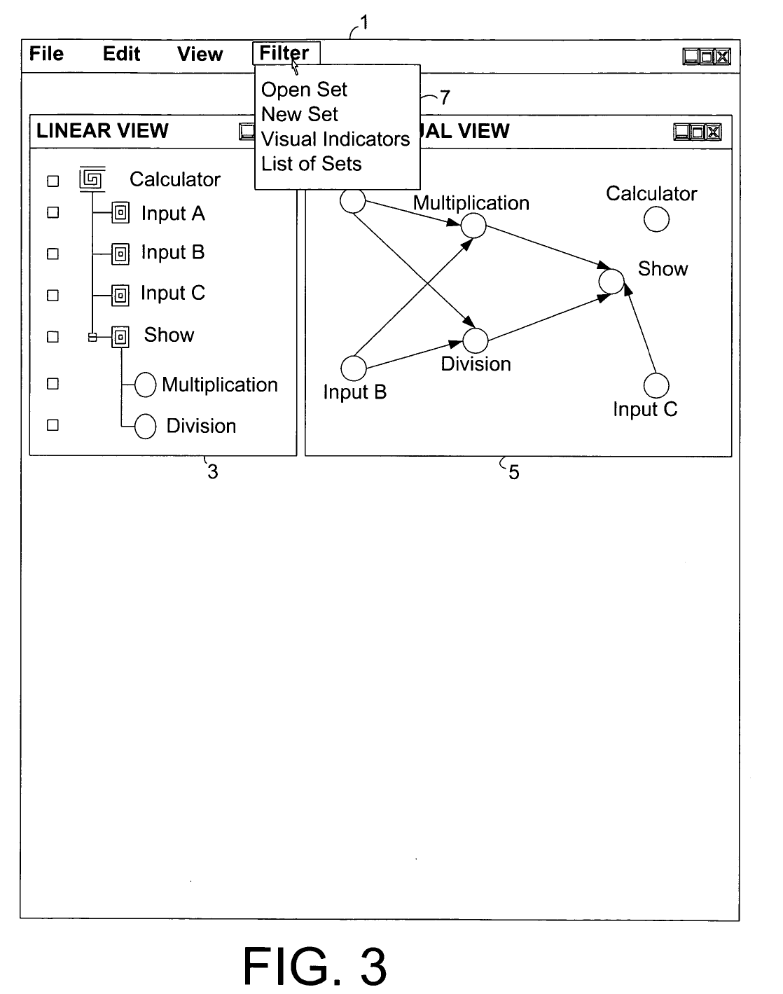

FIG. 3 illustrates the window 1, comprising the first and second panes 3 and 5, wherein a Filter menu 7 is displayed.

In order to specify potential errors, the user clicks on a label “Filter” displayed in the window 1, in response to which, a Filter menu 7 is displayed. Subsequently, he clicks on the entry “New Set”, and a corresponding pane providing means for establishing a set of filters is displayed within the window 1.

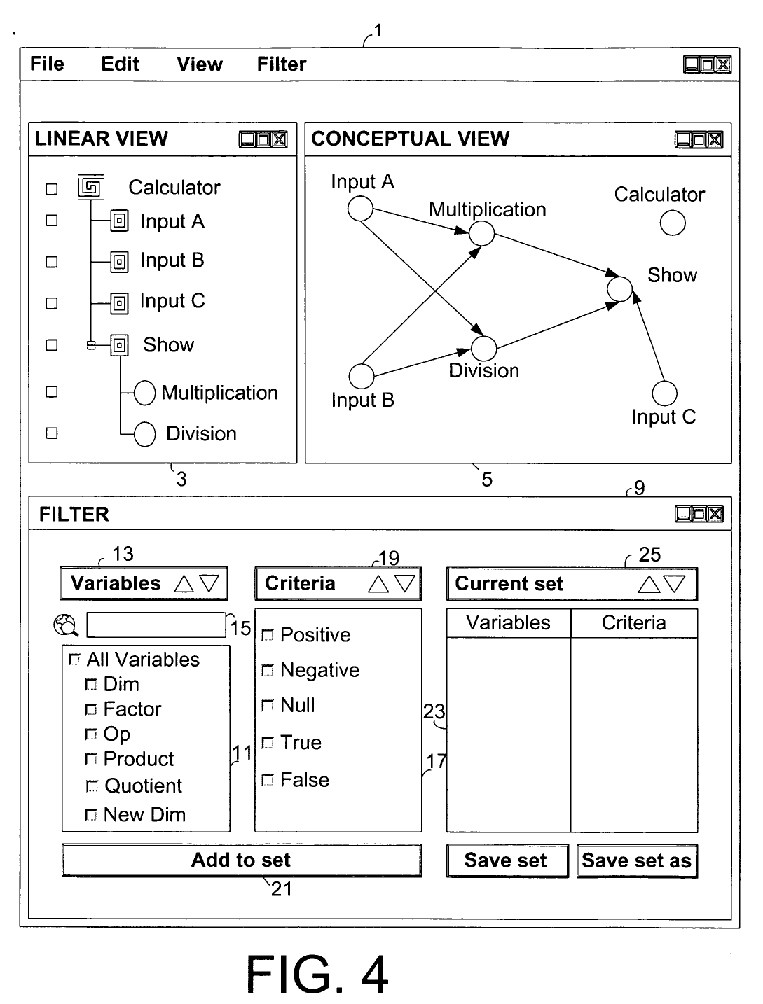

FIG. 4 illustrates the window 1, comprising the first and second panes 3 and 5, as well as a third pane 9 providing means for establishing a set of filters.

In the following description, the term “filter” shall be taken to designate a criterion of incoherence comprised of a combination of a variable and at least one predicate, and the term “filtered variable”, a variable associated to a filter. Furthermore, the term “predicate” shall be taken to designate a function stored in memory which, when applied to a variable, returns a Boolean value.

The pane 9 presents a view 11 of a list of variables of the program. In the preferred embodiment, a check box is associated to each entry in order to provide users with a means for selecting corresponding variables. Furthermore, all variables of the program are comprised in the list. However, in another embodiment, the user may restrict variables comprised in the list to those being of a type of interest.

In the case of a substantially complex program, the view 11 may not comprise the list of variables in its entirety due to spatial constraints. Consequently, a scroll button 13 is provided allowing users to manually search through the list. In the preferred embodiment, a search box 15 is also provided, wherein a user may enter a name of a variable of interest, in response to which the view 11 is shifted such that a corresponding entry is displayed therein.

The pane 9 also presents a view 17 of a list of predicates, wherein a check box is associated to each entry in order to provide users with means for conveniently selecting corresponding predicates. In the preferred embodiment, a list of basic predicates is provided by default to the user, and custom predicates may be imported from predicate libraries. However, in another embodiment, predicates are separated into groups according to types of variables to which they may be applied, and groups corresponding to types of variables comprised in the list of variables are incorporated into the list of predicates. In the case where a substantial number of predicates are defined, the view 19 may not comprise the entire list due to spatial constraints. Consequently, a scroll button 19 is provided allowing users to manually search through the list.

The pane 9 presents another view 23, divided into two lists, the first of which comprises filtered variables comprised in a current set of filters, and the second, corresponding predicates. In the case where a substantial number of filters have been defined, the view 23 may not comprise the lists in their entirety due to spatial constraints. Consequently, a scroll button 25 is provided allowing users to manually search through the lists.

The user may specify a filter by selecting a variable from the list of variables comprised in the view 11, selecting at least one corresponding predicate from the list of predicates comprised in the view 17, and clicking on a button 21, in order to add the filter to a current set of filters. Subsequently, the selected variable is added to the list of filtered variables, and the at least one selected predicate, to the list of corresponding predicates.

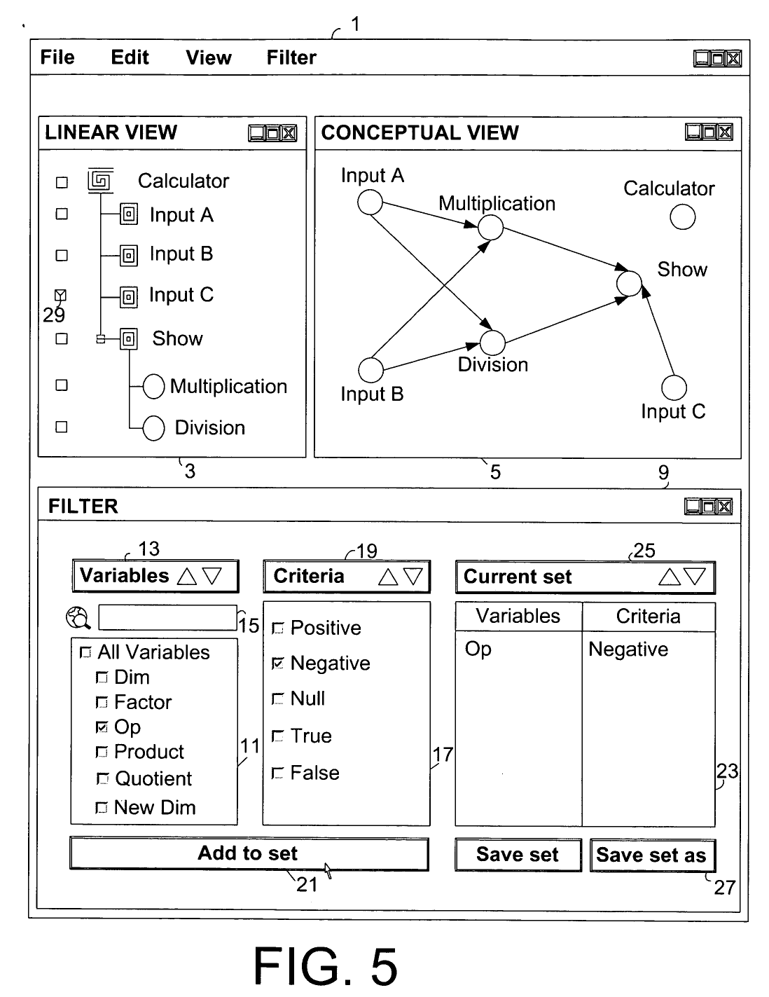

FIG. 5 illustrates the window 1, comprising the panes 3, 5, and 9, wherein a set of filters is being established.

Prior to establishing the list of filters, the user must identify, for each variable of notable importance, which potential values would inextricably be considered erroneous, or considerably diverge from his expectations. In the case of the program Calculator, the user notes that the variables Dim, Factor, Selector, Product, and Quotient, may not be assigned negative values. Furthermore, the variable Factor may not be assigned a null value.

Subsequently, the user establishes the corresponding filters within the pane 9 by making the appropriate selections from the list of variables comprised in the view 11, and the list of predicates comprised in the view 17. For instance, the user may select the variable Op from the list of variables comprised in the view 13, the predicate “Negative”, from the list of predicates comprised in the view 17, and click on the button 21, in order for a corresponding filter to be added to a current set.

Once the user clicks on the button 21, the variable Op and the predicate Negative are added to the lists comprised in the view 25, as shown in FIG. 5. Furthermore, an icon 29 is displayed within the pane 3, in a box adjacent to a node representing the object Input C, in order to indicate that the latter comprises a filtered variable.

In the preferred embodiment, when all filters of a current set are believed to have been established, the user clicks on a button 27 in order to provoke a display of a pane providing means for assigning a name to, and saving, a set of filters, within the window 1.

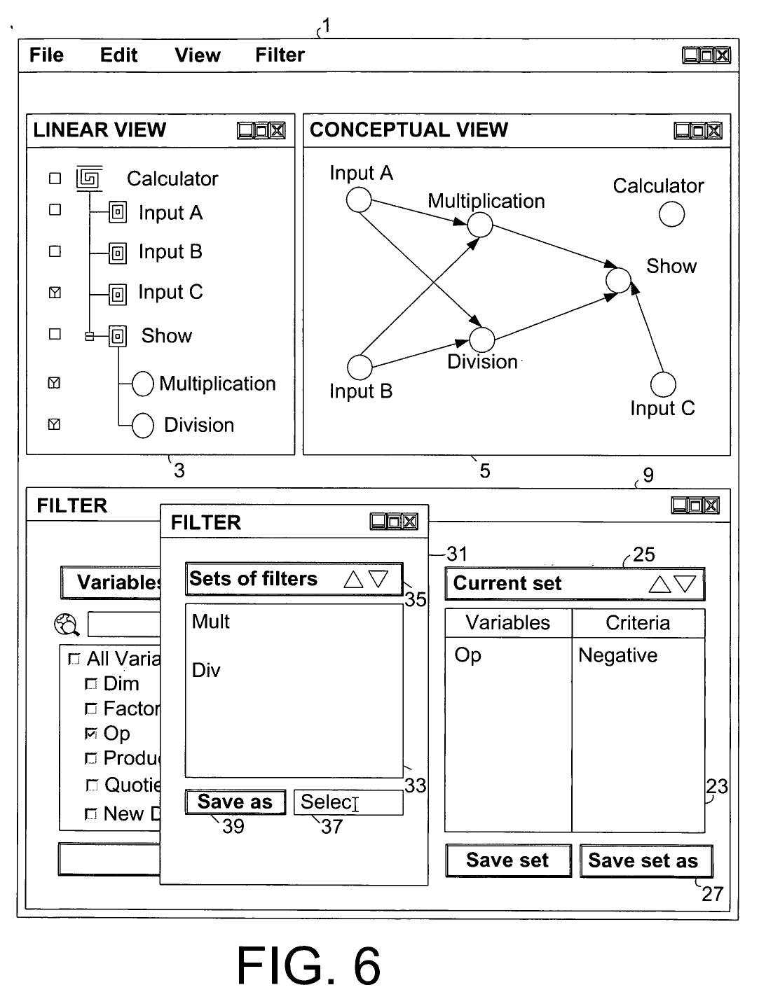

FIG. 6 illustrates the window 1, comprising the panes 3, 5, and 9, as well as a fourth pane 31 providing means for assigning a name to, and saving, a current set of filters.

The pane 31 presents a view 33 of a list of all previously saved sets of filters associated to a debugging process of the program. In the case illustrated in FIG. 6, sets labeled “Mult” and “Div” have been previously established. In the case where a substantial number of sets of filters have been saved, the list may not be comprised within the view 33 in its entirety. Consequently, a scroll button 35 is provided allowing users to manually search through the list. The pane 31 also comprises a text box, wherein the user may enter a name he would like to assign to the current set of filters. Adjacent to the text box is a button 39, which, when clicked, causes the current set of filters to be saved in memory as associated to the name specified in the text box 37.

In the case illustrated in FIG. 6, the user specifies a name that he would like assign to the current set of filters in the text box 37, namely “Select”, and clicks on the button 39, in response to which the set is added to the list of sets of filters, and saved in memory as “Select”.

In some cases, the user might wish to view or edit a saved set of filters, wherein editing might consist in adding, removing, adding a predicate to, or removing a predicate from, a filter. Referring to FIG. 3, the user may do so by selecting an “Open Set” entry from the Filter menu 7, in response to which, a pane is displayed providing means for selecting a saved set in order for its settings to be displayed.

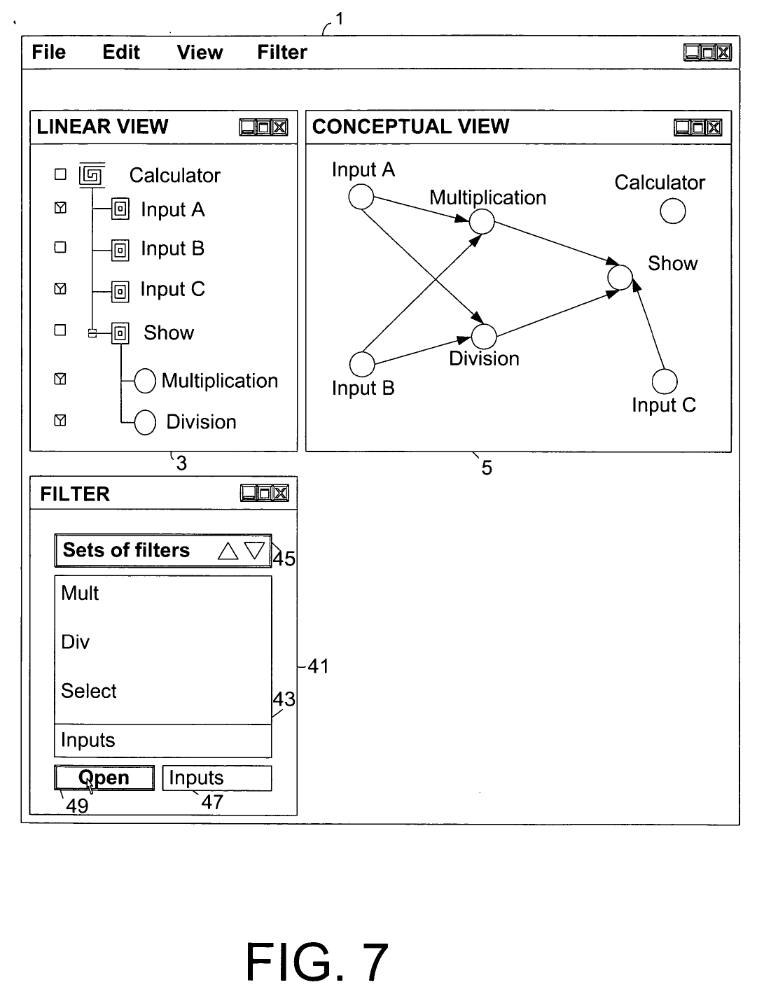

FIG. 7 illustrates the window 1 comprising the panes 3 and 5, as well as a third pane 41 providing means for selecting a saved set in order for its settings to be displayed.

The pane 41 presents a view 43 comprising a list of all saved sets of filters, namely “Mult”, “Div”, “Select”, and “Inputs”. In the case where a substantial number of sets of filters have been saved, the list may not be comprised within the view 43 in its entirety. Consequently, a scroll button 45 is provided allowing users to manually search through the list. The pane 41 also comprises a text box 47, wherein a name of a set of interest is displayed. Adjacent to the text box 47 is a button 49 which, when clicked, provokes the display of the pane 9 within the window 1, wherein the pane 9 presents the settings of a set corresponding to the name displayed in the text box 47.

In the particular case illustrated in FIG. 7, the user wishes to display the settings of the set of filters named “Inputs”. Consequently, he selects a corresponding entry from the list comprised in the view 43, which provokes the display of the name “Inputs” in the text box 47, and clicks on the button 49, in order for the pane 9 to be displayed within the window 1, wherein the pane 9 presents the settings of the set of filters Inputs. In another embodiment, the user provokes the aforementioned display of the pane 9 by typing the name “Inputs” in the text box 47, and clicking on the button 49.

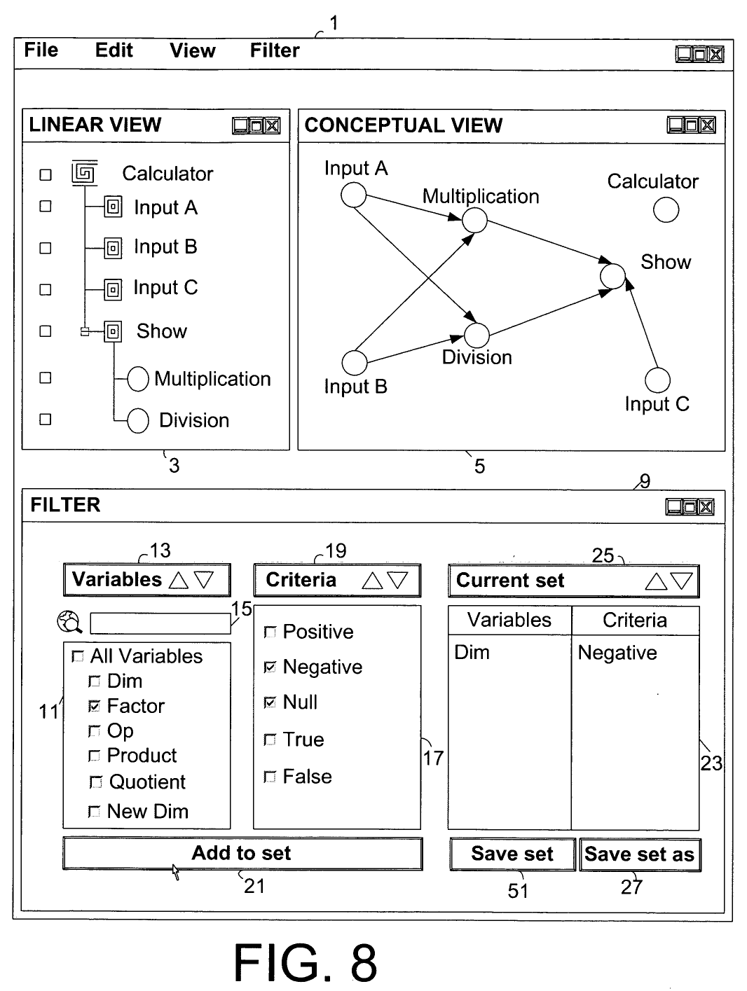

FIG. 8 illustrates the window 1 comprising the panes 3 and 5, as well as the third pane 9, wherein a filter is added to the selected saved set.

As shown in the view 23 presented by the pane 9, the set of filters Inputs comprises a filter combining the variable Dim with the predicate Negative.

However, the user notices that the variable Factor may only be assigned strictly positive values, and consequently, wishes to add a filter combining the variable Factor with the predicate Negative, and a predicate “Null”. In order to add such a filter, the user selects the variable Factor from the list of variables comprised in the view 13 and the predicates Negative and Null from the list of predicates comprised in the view 17. Subsequently, he clicks on the button 21, thereby causing the filter to be added to the set of filters Inputs, and the relevant variable and predicates, to be displayed within the lists comprised in the view 23. Thereafter, the user clicks on a button 51 in order to save the modifications brought to the set of filters Inputs.

In the preferred embodiment, once all potential errors have been identified and translated into corresponding sets of filters, the user designates visual indicators that will be provided to nodes representing objects of interest according to a last execution of the program. More specifically, the user designates a first visual indicator for nodes representing suspect objects, a second one for those representing target objects, and a third, for those representing victim objects. In another embodiment, the user also designates visual indicators that will be provided to links representing data flow relationships of interest. More specifically, the user designates a fourth visual indicator that will be provided to links representing data flow relationships between a target object and corresponding suspect objects, and a fifth visual indicator that will be provided to those representing data flow relationships between a target object and corresponding victim objects. In yet another embodiment, the visual indicators are designated by default.

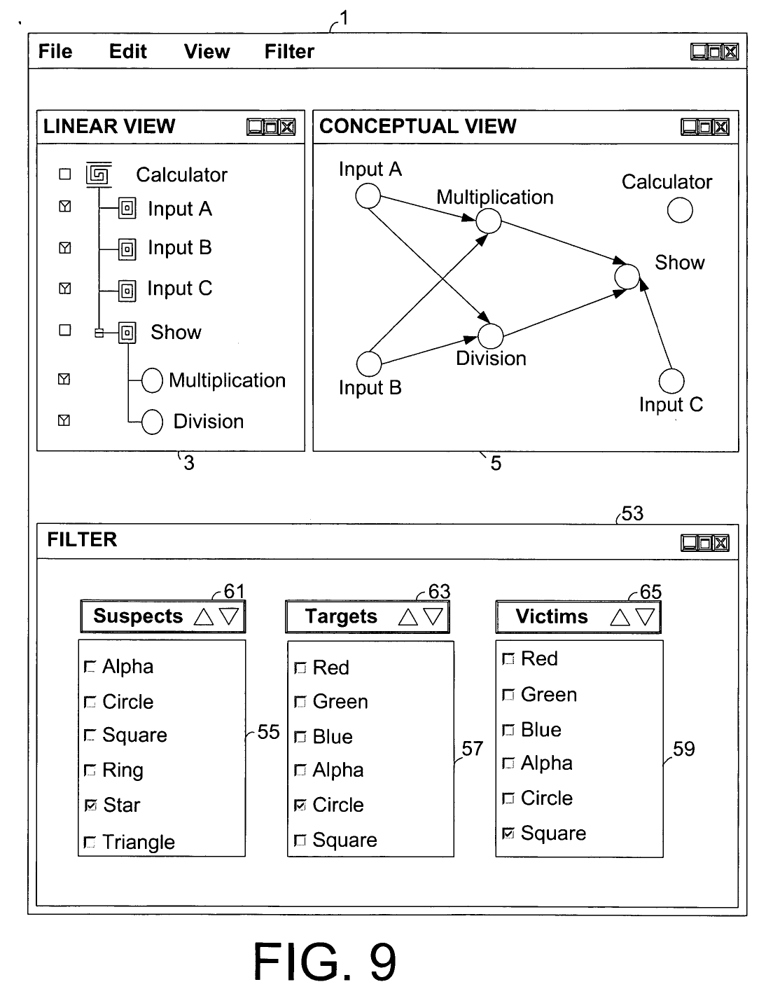

FIG. 9 illustrates the window 1 comprising the panes 3 and 5, as well as a third pane 53 providing means for selecting visual indicators.

The pane 53 comprises three views 55, 57, and 59 of a same list of visual indicators, wherein each one of the latter is associated to a corresponding graphical representation stored in memory. In the preferred embodiment, a check box is associated to each entry in the list in order to provide means for conveniently selecting corresponding indicators. However, in another embodiment, an indicator may be selected by clicking on a corresponding entry.

In the case where a substantial number of visual indicators have been established, the list may not be comprised within the views 55, 57, and 59 in its entirety. Consequently, scroll buttons 61, 63, and 65, are provided allowing users to manually search through the list within the views 55, 57, and 59 respectively.

In the views 55, 57, and 59, the user may select visual indicators that will distinguish nodes representing suspect, target, and victim objects respectively from all other nodes representing objects of the program within the pane 5. It is important to note that the user is not required to select a visual indicator from each one of the views 55, 57, and 59. For instance, he may ignore the list comprised in the view 59 if he does not wish to distinguish nodes representing victim objects. On the other hand, he may choose to distinguish nodes representing victim objects through more than one visual indicator, in which case he would select a corresponding number of indicators from the list comprised in the view 59.

In another embodiment, the visual indicators are provided to nodes displayed in the pane 3, instead of the pane 5. In yet another embodiment, the visual indicators are provided to nodes displayed in panes 3 and 5. In yet another embodiment, the user may chose whether he would like for visual indicators to be provided for nodes displayed in the pane 3, 5, or both panes 3 and 5.

In the particular case illustrated in FIG. 9, the user has selected “Star” from the list presented in the view 55, “Circle” from the list comprised in the view 57, and “Square” from the list comprised in the view 59. Consequently, following an execution of the program, nodes representing suspect objects would be surrounded by a graphical representation of a star, those representing target objects, by that of a circle, and those representing victim objects, by that of a square.

Alternatively, a visual indicator “Visible” may be selected, such that only nodes representing corresponding objects of interest are visible whereby overcrowded views presented by the pane 5 may be alleviated for the purposes of a debugging process.

If a conventional error, such as an overflow or a null-pointer, is detected during an execution of a program, the execution is interrupted, and the list of visual indicators is accessed in order to provide nodes representing target, suspect, and victim objects with corresponding visual indicators. Otherwise, the user may further the debugging process following a completed execution of the program by selecting sets of filters from those that were previously defined in order for them to be applied. If such is the case, filtered variables and predicates corresponding to the selected sets of filters are retrieved, and the retrieved predicates are applied to corresponding retrieved filtered variables. When an error is detected, the list of visual indicators is accessed in order to provide nodes representing target, suspect, and victim objects with corresponding visual indicators.

Referring back to FIG. 3, in order to select defined sets of filters, the user selects the entry “List of Sets” from the Filter Menu 7, in response to which, a pane providing means for applying saved sets of filters is displayed within the window 1.

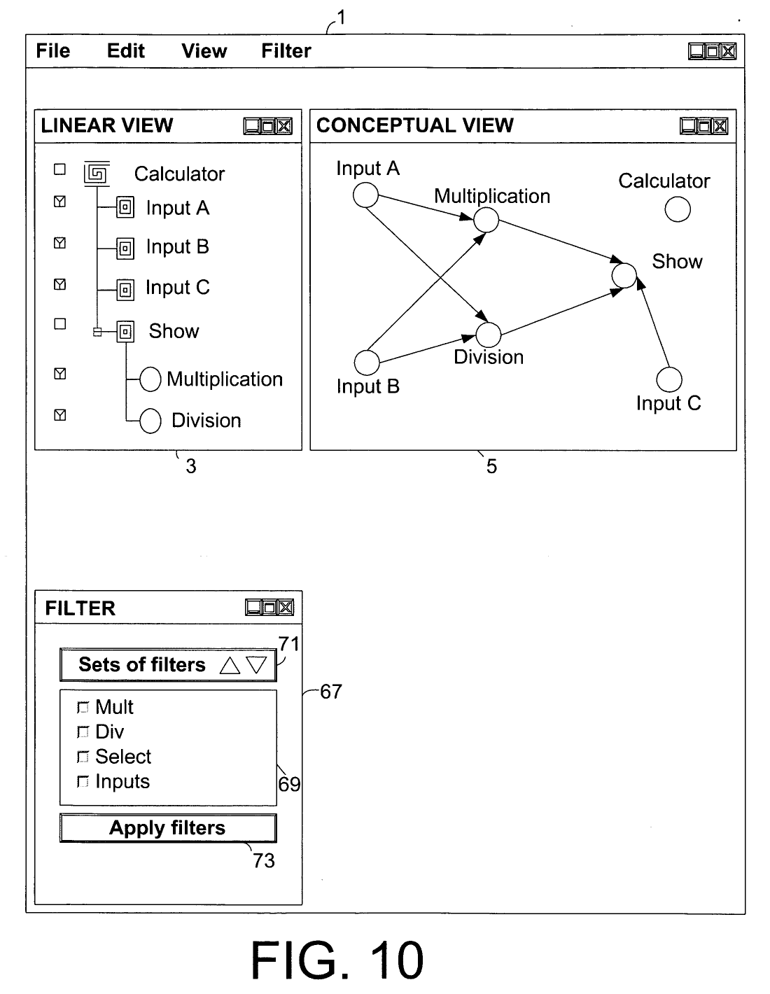

FIG. 10 illustrates the window 1 comprising the panes 3 and 5, as well as a third pane 67 providing means for applying saved sets of filters.

The pane 67 comprises a view 69 of a list of all saved sets of filters. A check box is associated to each entry of the list in order to provide means for selecting corresponding sets of filters. In the case where a substantial number of sets of filters have been saved, the list may not be comprised within the view 69 in its entirety. Consequently, a scroll button 71 is provided allowing the user to manually search through the list.

The user selects the desired sets of filters from the list comprised in the view 69 and clicks on a button 73, in order to initiate a filtering process. Subsequently, for each selected set, corresponding filters are retrieved, and for each retrieved filter, corresponding predicates are applied to values assigned to corresponding filtered variables.

If a predicate returns True, a value assigned to a corresponding filtered variable is considered erroneous, and an object in which the filtered variable is comprised, a target. The latter is accessed in order for coordinates of a node through which it is represented within the pane 5 to be retrieved. Then, the list of visual indicators is retrieved in order for a visual indicator selected to distinguish nodes representing target objects from others to be identified, a graphical representation of the selected visual indicator is retrieved, the target object is, and the retrieved graphical representation is displayed as surrounding the node representing the target object according to the retrieved coordinates.

Subsequently, the target object is accessed in order to retrieve a pointer to its parent, and a graphical representation of a visual indicator selected to distinguish nodes representing suspect objects from others is displayed as surrounding a node representing the parent object within the pane 5, according to the same method by which a graphical representation of a visual indicator is displayed as surrounding a node representing a target object.

The target object is thereafter accessed in order for pointers to all objects from which it receives data according to its list of data flow relationships to be retrieved, and the graphical representation of the visual indicator selected to distinguish nodes representing suspect objects from others is displayed as surrounding a node representing the parent object within the pane 5, according to the same method by which a graphical representation of a visual indicator is displayed as surrounding a node representing a target object.

In the preferred embodiment, the steps described above according to which a parent of, and objects from which data is retrieved by, a target object are located, and nodes through which they are represented are visually distinguished from others, are performed recursively for each suspect object until every node representing an object upon which an execution of the target object might be dependent is identified as representing a suspect object within the pane 5.

In another embodiment, the steps described above are performed only once. In yet another embodiment, the number of times the steps described above are performed are performed recursively is defined by the user.

Thereafter, the target object is accessed in order for pointers to its children to be retrieved, and a graphical representation of a visual indicator selected to distinguish nodes representing victim objects is displayed as surrounding nodes representing the children within the pane 5, according to the same method by which a graphical representation of a visual indicator is displayed as surrounding a node representing a target object.

Subsequently, the target object is accessed in order for pointers to all objects involved at a receiving end of a relationship according to its list of data flow relationships to be retrieved, and a graphical representation of a visual indicator selected to distinguish nodes representing victim objects from others is displayed as surrounding nodes representing objects corresponding to the retrieved coordinates within the pane 5, according to the same method by which a graphical representation of a visual indicator is displayed as surrounding a node representing a target object.

In the preferred embodiment, the steps described above according to which children of, and objects involved at a receiving end of a relationship with, a target object are located, and nodes through which they are represented within the pane 5 are visually distinguished from others, are performed recursively for each victim object until every node representing an object which might be dependent upon an execution of the target object is identified as representing a victim object within the pane 5.

In another embodiment, the steps described above are performed only once. In yet another embodiment, the number of times the steps described above are performed are performed recursively is defined by the user.

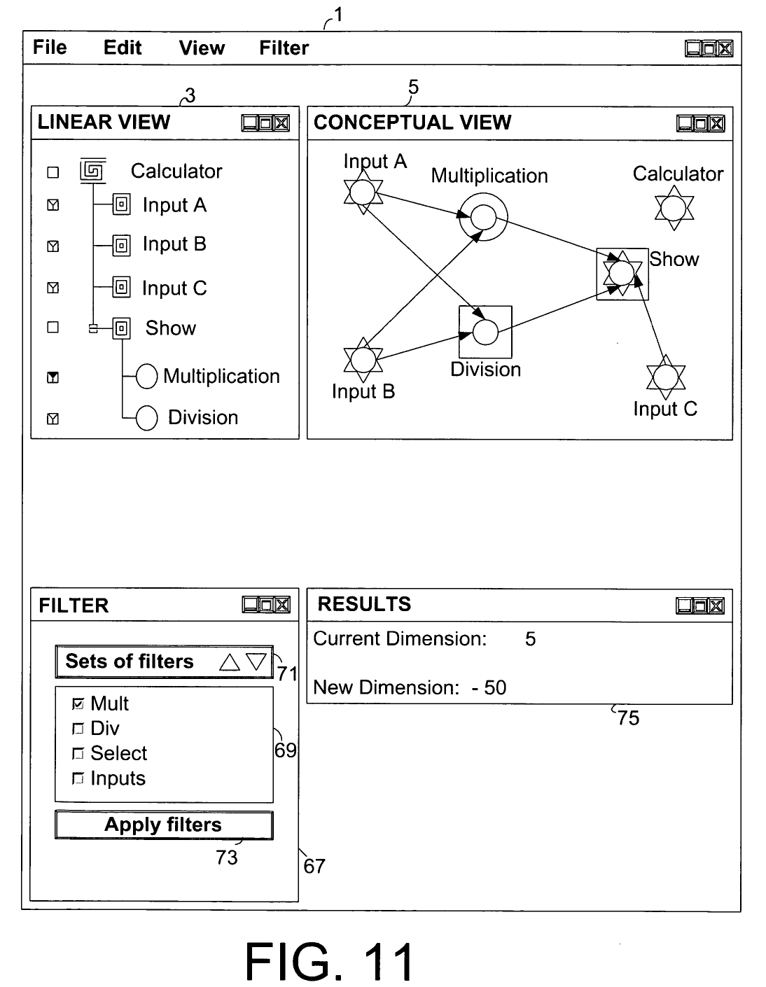

FIG. 11 illustrates the window 1 comprising the panes 3, 5, and 67, as well as a fourth pane 75 presenting a view of results of a last execution of the program, wherein a set is selected through the pane 67, and visual indicators are provided to nodes displayed in the pane according to the selected set and the last execution of the program.

After examining the pane 75, the user notices that a value of a new dimension of the image calculated during a last execution of the program is negative, which is not acceptable. He also notices that the absolute value of the new dimension is greater than that of the current one, which implies that the former value was calculated following a request to enlarge the image. Knowing that such values are calculated by the object Multiplication, he selects the set of filters Mult from the list of sets of filters comprised in the view 69.

As a result of selecting the set of filters Mult, the filters associated to the latter are retrieved, namely a combination of the variable Product and the predicate Negative. Then, a value of the variable Product, −50, is retrieved from the object Multiplication, the predicate Negative is applied to the retrieved value, and consequently, the latter is identified as erroneous, and the object Multiplication, as a target. Consequently, the latter object is accessed in order for coordinates of a node through which it is represented within the pane 5 to be retrieved. The list of visual indicators is searched in order for a visual indicator selected to distinguish nodes representing target objects from others to be identified. In this particular case, the visual indicator “Circle” had been selected, and therefore, a graphical representation of a circle is retrieved and displayed as surrounding the node corresponding to the retrieved coordinates.

Subsequently, the object Multiplication is accessed in order to retrieve a pointer to its parent, namely the object Show. The latter is accessed through the retrieved pointer in order for coordinates of a node through which it is represented within the pane 5 to be retrieved. Then, the list of visual indicators is searched in order for a visual indicator selected to distinguish nodes representing suspect objects from others to be identified. In this particular case, the visual indicator “Star” had been selected and therefore, a graphical representation of a star is retrieved and displayed as surrounding the node corresponding to the retrieved coordinates.

The object Multiplication is accessed in order for pointers to all objects from which it receives data according to its list of data flow relationships to be retrieved, namely the objects Input A and Input B. The latter objects are accessed through the retrieved pointers in order for coordinates of nodes through which they are represented within the pane 5 to be retrieved, and the retrieved graphical representation of a star is displayed as surrounding the nodes corresponding to the retrieved coordinates.

Thereafter, the method according to which the objects Show, Input A, and Input B were identified as suspect objects from the object Multiplication is applied recursively to each suspect object. The object Show is accessed in order for a pointer to its parent to be retrieved, namely the object Calculator. The latter object is accessed in order for coordinates of a node through which it is represented within the pane 5 to be retrieved, and the retrieved graphical representation of a star is displayed as surrounding the node corresponding to the retrieved coordinates.

The object Show is subsequently accessed in order for pointers to all objects from which it receives data according to its list of data flow relationships to be retrieved, namely the objects Input A, Input B, and Input C. The object Input A is accessed in order for coordinates of a node through which it is represented within the pane 5 to be retrieved. However, the node corresponding to the retrieved coordinates is ignored since it is already surrounded by the graphical representation of a star. For the same reason, a located node through which the object Input B is represented within the pane 5 is ignored. As for the objects Input C, a node through which it is represented within the pane 5 is displayed as surrounded by the graphical representation of a star.

Thereafter, the hierarchical and data flow relationships of the object Calculator are analyzed in order to locate additional suspect objects. However, since the Calculator does not have a parent and is not involved at a receiving end of a data flow relationship, no additional suspect objects are located therefrom.

Subsequently, the object Input C is accessed in order for a pointer to its parent to be retrieved, namely the object Calculator. The latter object is accessed through the retrieved pointer in order for coordinates of a node through which it is represented within the pane 5 to be retrieved. However, the node corresponding to the retrieved coordinates is ignored since it is already surrounded by the graphical representation of a star.

Thereafter, the object Input C is accessed in order for pointers to objects from which it retrieves data according to its list of data flow relationships to be retrieved. Since the object Input C is not involved at a receiving end of a data flow relationship, no additional suspect objects are detected therefrom. Similarly, the analysis of the data flow and hierarchical relationships of the objects Input A and Input B does not lead to additional suspect objects.

Since all suspect objects have been identified, the object Multiplication is accessed in order for pointers to its children to be retrieved, namely the object Show. However, the object Multiplication does not have any children, and the search for victim objects segues with an analysis of its outgoing data flows.

The object Multiplication is accessed in order for pointers to all objects involved at a receiving end of a relationship according to its list of data flow relationships to be retrieved, namely the object Show, and the latter is accessed through the retrieved pointer in order to retrieve coordinates of a node through which it is represented within the pane 5. Consequently, the list of visual indicators is searched in order for a visual indicator selected to distinguish nodes representing suspect objects from others is identified. In this particular case, the visual indicator “Square” had been selected and therefore, a graphical representation of a square is retrieved and displayed as surrounding the node corresponding to the retrieved coordinates.

Thereafter, the object Show is accessed in order for a pointer to its children to be retrieved, namely the objects Multiplication and Division. The object Multiplication is ignored since it is the target. On the other hand, the object Division is accessed in order for coordinates of a node through which it is represented within the pane 5 to be retrieved, and the retrieved graphical representation of a square is displayed as surrounding the node corresponding to the retrieved coordinates.

The object Show is thereafter accessed in order for pointers to objects involved at a receiving end of a relationship according to its list of data flow relationships to be retrieved. However, since there is no such object specified in the list, no additional victim objects are detected therefrom.

The object Division is thereafter accessed in order for pointers to its children to be retrieved. However, since it does not have any children, the search for victim objects segues with an analysis of its outgoing data flows.

The object Division is accessed in order for objects involved at a receiving end of a relationship according to its list of data flow relationships to be retrieved, namely the object Show. The latter is accessed in order for coordinates of a node through which it is represented within the pane 5 to be retrieved. However, the node corresponding to the retrieved coordinates is ignored since it is already surrounded by the graphical representation of a square.

Once a user applies a set of filters, he may easily determine whether a target object has been identified, and if so, which suspect objects have been identified as associated to the target object, due to visual indicators provided within the pane 5. Consequently, he may verify whether the suspect objects comprise filtered variables by verifying icons displayed in boxes associated to corresponding nodes within the pane 3. If they do comprise filtered variables, he may apply a corresponding filter in order to verify whether their values are erroneous, and orient his debugging process accordingly.

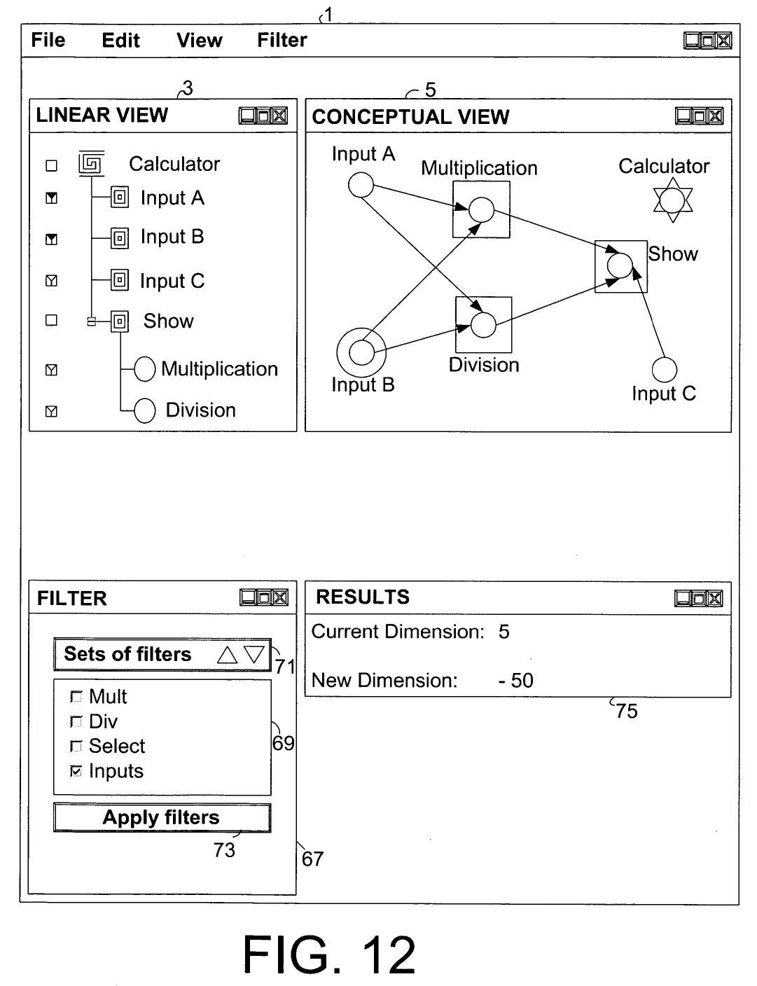

FIG. 12 illustrates the window 1 comprising the panes 3, 5, 67, and 75, wherein another complementary set is selected through the pane 67, and visual indicators are provided to nodes displayed in the pane 5 according to the selected set.

When the user applied the set of filters Mult, a target object, namely the object labeled Multiplication, and four associated suspect objects, namely the objects Input A, Input B, Input C, and Show have been identified. Upon viewing filtering boxes displayed within the pane 3 as associated to nodes representing the objects of the program, the user notices that the suspect objects Input A and Input B comprise at least one filtered variable. Consequently, he requests an application of a corresponding set of filters Inputs by selecting a corresponding entry from the list comprised within the view 69. Alternatively, the user may perform the request by clicking on an icon comprised in a box associated to a node representing either one of the objects Input A and Input B within the pane 3.

As a result of the performed request, the filters associated to the set of filters Inputs are retrieved, namely a combination of the variable Dim and the predicate Negative, and that of the variable Factor and the predicates Negative and Null. Subsequently, a value assigned to the variable Dim, 5, is retrieved from the object Input A, the predicate Negative is applied to the retrieved value, and consequently, the latter value is not considered erroneous. Similarly, a value assigned to the variable Factor, −10, is retrieved from the object Input B, the predicate Negative is applied to the retrieved value, and consequently, the latter value is identified as erroneous, and the object Input B, as a target. Consequently, the latter object is accessed in order for coordinates of a node through which it is represented within the pane 5 to be retrieved, and the retrieved graphical representation of a circle is displayed as surrounding the node corresponding to the retrieved coordinates.

Thereafter, the object Input B is accessed in order for a pointer to its parent to be retrieved, namely the object Calculator. The latter is accessed through the retrieved pointer in order for coordinates of a node through which it is represented within the pane 5 to be retrieved. Subsequently, the graphical representation of a star is retrieved and displayed as surrounding the node corresponding to the retrieved coordinates.

The object Input B is subsequently accessed in order for pointers to all objects from which it receives data according to its list of data flow relationships to be retrieved. Since the object Input B is not involved at a receiving end of a relationship, no additional suspect objects are detected therefrom.

Thereafter, the hierarchical and data flow relationships of the object Calculator are analyzed in order to locate additional suspect objects. However, since the Calculator does not have a parent and is not involved at a receiving end of a data flow relationship, no additional suspect objects are located therefrom.

Since all suspect objects have been located, the object Input B is accessed in order for pointers to all objects involved at a receiving end of a relationship according to its list of data flow relationships to be retrieved, namely the objects Multiplication and Division. The latter objects are accessed through the retrieved pointers in order for coordinates of nodes through which they are represented within the pane 5 to be retrieved. Then, the graphical representation of a square is retrieved and displayed as surrounding the nodes corresponding to the retrieved coordinates.

The object Multiplication is subsequently accessed in order for pointers to all its children to be retrieved. However, since it does not have any children, the search for victim objects segues with an analysis of its outgoing data flows.

The object Multiplication is accessed in order for pointers to all objects involved at a receiving end of a relationship according to its list of data flow relationships to be retrieved, namely the object Show. The latter is accessed through the retrieved pointer in order for coordinates of a node through which it is represented within the pane 5 to be retrieved, and the retrieved graphical representation of a square is displayed as surrounding a node corresponding to the retrieved coordinates.

The object Show is subsequently accessed in order for pointers to all its children to be retrieved, namely, the objects Multiplication and Division. The object Multiplication is accessed in order for coordinates of a node through which it is represented within the pane 5 to be retrieved. However, the node corresponding to the retrieved coordinates is ignored since it is already surrounded by the graphical representation of a square. Similarly, a located node through which the object Division is represented within the pane 5 is ignored.

The object Show is subsequently accessed in order for pointers to all objects involved at a receiving end of a relationship according to its list of data flow relationships to be retrieved. Since no such object is found, no additional suspect objects are detected therefrom.

Thereafter, the object Division is accessed in order for pointers to all its children to be retrieved. However, since it does not have any children, the search for victim objects segues with an analysis of its outgoing data flows.

Finally, the object Division is accessed in order for pointers to all objects involved at a receiving end of a relationship according to its list of data flow relationships to be retrieved, namely the object Show. The latter is accessed through the retrieved pointer in order for coordinates of a node through which it is represented within the pane 5 to be retrieved. However, the node corresponding to the retrieved coordinates is ignored since it is already surrounded by the graphical representation of a square.

The application of the sets of filters Mult and Inputs informs the user that an error detected within the object Multiplication might have been caused by the object Input B, and an error detected within the object Input B might have been propagated through the object Multiplication. Consequently, it would be more efficient to debug the error located within the object Input B prior to the one located within the object Multiplication. According to visual indicators provided within the pane 5, a cause of the error detected within the object Input B may be located in the latter, or in the object Calculator. However, since the sole purpose of the object Calculator is to provide a reference to the program, the cause of the error is more likely to be comprised within the object Input B.

In order to be provided with a detailed description of a detected error, the user moves the mouse pointer over a location of a node representing a corresponding target object, and waits for an amount of time indicating his interest in the error, in response to which the target object is identified, the applied sets of filters are searched in order for filtered variables comprised in the target object to be identified along with corresponding predicates. Subsequently, values assigned to the identified variables are retrieved, and erroneous ones are identified as such according to corresponding predicates. Finally, a tool tip is displayed within the pane 5 as associated to the node designated by the mouse pointer, specifying which of the identified filtered variables have been assigned an erroneous value, the erroneous values themselves, as well as the predicates used to identify those values as erroneous.

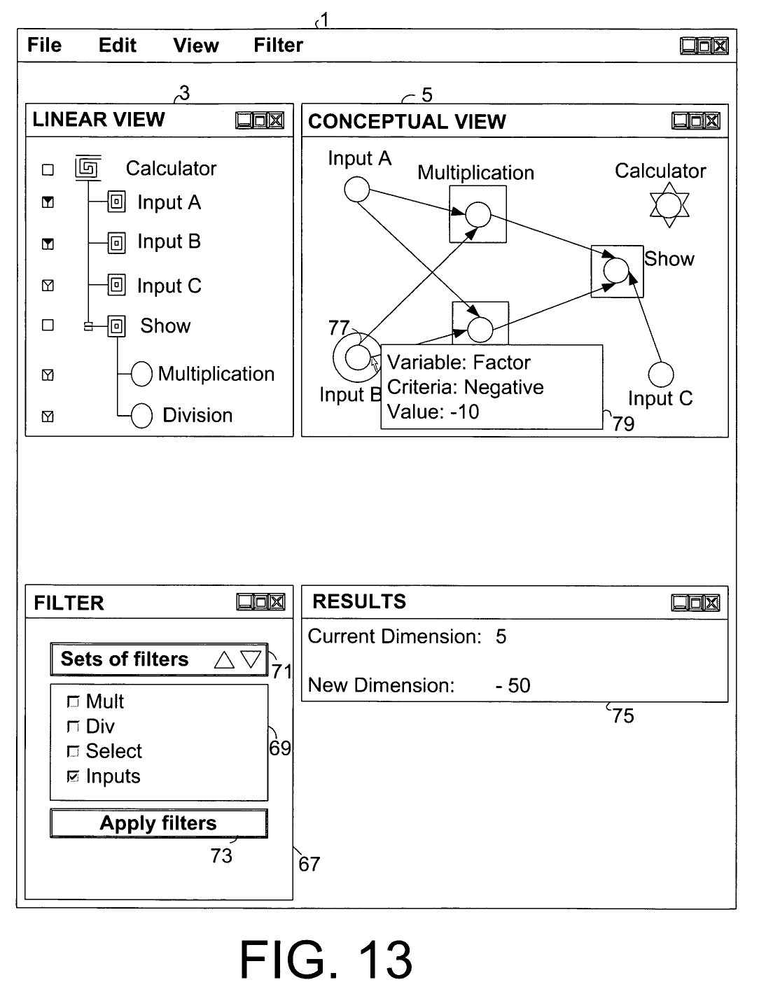

FIG. 13 illustrates the window 1 comprising the panes 3, 5, 67, and 75, wherein visual indicators are provided to nodes displayed in the pane 5 according to a selected set of filters and a last execution of the program, and a tool tip 79 describing a detected error is displayed as associated to a node 77 representing a corresponding program object.

The user wishes to be provided with a detailed description of the error detected within the object Input B. Consequently, he moves the mouse pointer over the node 77 within the pane 5, and waits for an amount of time indicating his interest in the detected error, in response to which the object Input B is identified, the set of filters Inputs is searched in order for filtered variables comprised in the object Input B, namely the variable Factor, as well as its corresponding predicates, namely the predicates Negative and Null, to be identified. Subsequently, the latter predicates are applied to a value assigned to the variable Factor, −10, retrieved from the object Input B, and as a result, the latter value is identified as erroneous. Consequently, a tool tip is displayed as associated to a node representing the object Input B within the pane 5, specifying the filtered variable that was assigned an erroneous value, namely the variable Factor, the erroneous value, −10, as well as the predicate used to identify the latter value as erroneous, namely the predicate Negative.

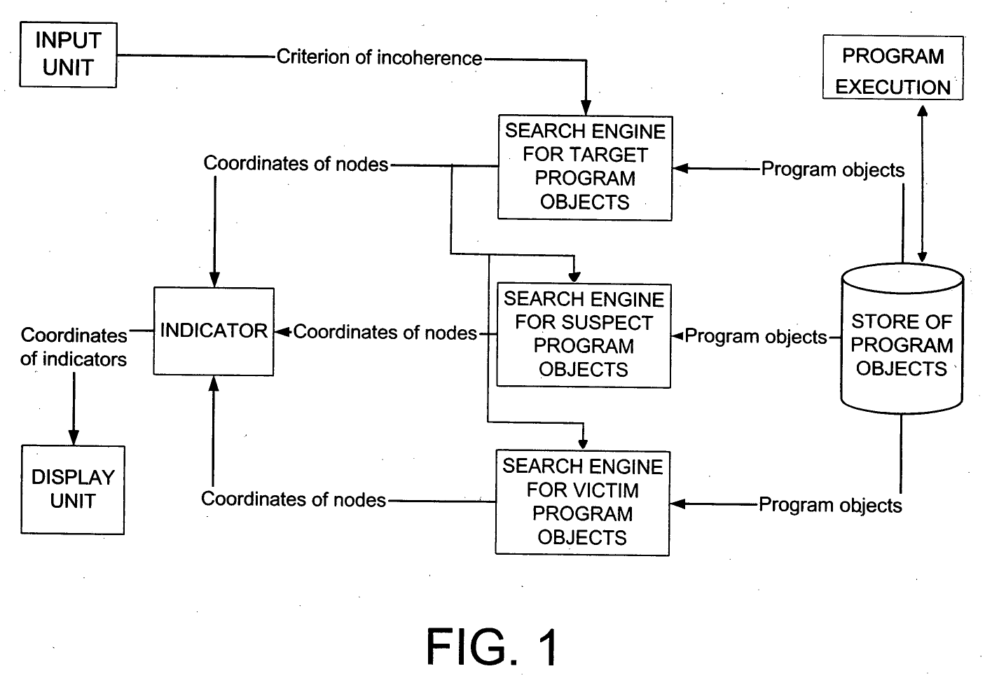

FIG. 1 illustrates an exemplary implementation of an apparatus performing the method described herein above. The apparatus may be implemented as a software application, using any known programming language, or as a hardware unit, using any known hardware design or hardware programming technique.

Although the present invention has been described as examining final values assigned to filtered variables during a last execution of the program, it could be easily extended to record and examine final values assigned to filtered variables during at least two last executions.

Although the present invention has been described as examining final values assigned to filtered variables during a last execution of the program, it could be easily extended to record and examine all values assigned to filtered variables during the execution.

Although the present invention has been described as examining final values assigned to filtered variables during a last execution of the program, it could be easily extended to record and examine all values assigned to filtered variables during at least two last executions.

Although the present invention has been described within the context of an application window comprising two panes, the first of which presents a view of a hierarchical structure of a program, and the second, a view of its data flow structure, it may very well be applied in the context of a window comprising a different number of panes, wherein the panes present views that differ from the ones described herein above.

Although the present invention has been described as operating in the context of a graphical representation of a program, it may very well operate in the context of a textual representation of a program.

Although the present invention has been described as providing a graphical indication as to whether a program object is a target object, a suspect object, or a victim object, it may very well provide a textual indication as to whether a program object is a target object, a suspect object, or a victim object.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A method of providing a debugging interface, comprising:
executing said program comprising a plurality of program objects;
searching said plurality of program objects for at least one criterion of incoherence wherein ones of said plurality of program objects that meet at least one of said at least one criterion are identified as target program objects;
searching said plurality of program objects for program objects upon which at least one target program object is dependent, wherein ones of said plurality of program objects upon which at least one target program object is dependent are identified as suspect program objects; and
indicating at least one target program object and at least one suspect program object from said plurality of program objects.

2. The method of claim 1, wherein said indicating comprises providing a display of a plurality of nodes wherein each node represents one of said plurality of program objects, providing for each node of said display a first visual indication of whether a corresponding program object is one of said at least one target program object, and providing for each node of said display a second visual indication of whether a corresponding program object is one of said at least one suspect program object.

3. The method of claim 1, further comprising specifying said at least one criterion of incoherence.

4. The method of claim 3, further comprising displaying a list of criteria, wherein said specifying comprises a user selecting said at least one criterion of incoherence from said list.

5. The method of claim 2, further comprising specifying said first visual indication.

6. The method of claim 2, further comprising specifying said second visual indication.

7. The method of claim 5, further comprising specifying said second visual indication.

8. The method of claim 7, further comprising displaying a list of visual indications, wherein said specifying said first visual indication comprises selecting said first visual indication from said list of visual indications, and said specifying said second visual indication comprises selecting said second visual indication from said list of visual indications.

9. The method of claim 2, wherein said first visual indication is a square surrounding a node for which it is provided, and said second visual indication is a circle surrounding a node for which it is provided.

10. The method of claim 1, wherein at least one of said at least one criterion is a combination of a filtered variable and a group of at least two predicates, said at least one target program object comprises said filtered variable, and a value of said filtered variable fulfills at least one predicate of said group.

11. The method of claim 10, further comprising selecting at least one of said plurality of program objects as comprised in a search group, wherein a scope of said searching said plurality of program objects for at least one criterion of incoherence is restricted to ones of said plurality of program objects comprised in said search group.

12. The method of claim 2, further comprising requesting for said first visual indication to be provided, wherein said providing for each node a first visual indication is performed in response to said requesting.

13. The method of claim 2, further comprising requesting for said second visual indication to be provided, wherein said providing for each node a second visual indication is performed in response to said requesting.

14. The method of claim 1, further comprising storing a list of said at least one target program object, requesting for said list to be retrieved, and displaying said list in response to said requesting.

15. The method of claim 2, further comprising displaying a plurality of links, each link relating directly at least two of said plurality of nodes, providing a third visual indication for a link that relates a program object to said at least one target program object either directly or through other program objects.

16. The method of claim 1, further comprising searching said plurality of program objects for program objects upon which at least one target program object is dependent, wherein ones of said plurality of program objects dependent upon at least one target program object are identified as victim program objects, and indicating at least one victim program object from said plurality of program objects.

17. A computer program product for providing a debugging interface comprising a computer usable storage medium having computer readable program code means embodied in the medium, the computer readable program code means comprising:
computer readable program code means for executing said program comprising a plurality of program objects;
computer readable program code means for searching said plurality of program objects for at least one criterion of incoherence wherein ones of said plurality of program objects that meet at least one of said at least one criterion are identified as target program objects;
computer readable program code means for searching said plurality of program objects for program objects upon which at least one target program object is dependent, wherein ones of said plurality of program objects upon which at least one target program object is dependent are identified as suspect program objects; and
computer readable program code means for indicating at least one target program object and at least one suspect program object from said plurality of program objects.
